(19) United States
(12) Patent Application Publication
(10) Pub. No.: US 2016/0226113 A1
(43) Pub. Date: Aug. 4, 2016

(54) BATTERY PACK

(71) Applicant: NANJING CHERVON INDUSTRY CO., LTD., Nanjing (CN)

(72) Inventor: Yuexiang Zhang, Nanjing (CN)

(21) Appl. No.: 15/005,331

(22) Filed: Jan. 25, 2016

(30) Foreign Application Priority Data
Jan. 29, 2015 (CN) 201510047351.2

(51) Int. Cl. H01M 10/659; H01M 10/643; H01M 2/10

(52) U.S. Cl. CPC H01M 10/659; H01M 2/1016; H01M 10/643

(57) ABSTRACT

A battery pack includes a first housing arranged on the outmost side of the battery pack, a second housing arranged within the first housing, battery cells which are at least partially contained in the second housing and a filling body which is at least filled a space between two adjacent battery cells. The filling body is arranged in the second housing. The filling body has a first specific heat capacity when a temperature of the filling body is below a first temperature and has a second specific heat capacity when the temperature of the filling body is above the first temperature.

### RELATED APPLICTION INFORMATION

This application claims the benefit under 35 U.S.C. §119(a) of Chinese Patent Application No. CN 201510047351.2, filed on Jan. 29, 2015, the disclosure of which is incorporated herein by reference in its entirety.

### FIELD OF THE DISCLOSURE

The present disclosure relates generally to power storage devices and, more particularly, to a battery pack.

### BACKGROUND OF THE DISCLOSURE

Battery packs can generate heat during the charging and discharging process. To, among other things, prolong the life of the battery packs, it is needed to avoid the temperature of the battery packs rising dramatically and make the battery packs work in a safe temperature range (for example less than 80 degrees C.). Further, in order to save the charging time of the battery packs after discharging, it is expected that the temperature of the battery packs can quickly drop to less than 60 degrees C. That is, the slower the temperature of the battery packs rises the better during the discharging process, and the quicker the temperature of the battery packs drops the better during the charging process. However, with the development of the Li-ion battery technology, the capacity and the discharging current of the battery packs are increased constantly so the temperature management of these battery packs becomes a very important problem in the field.

The statements in this section merely provide background information related to the present disclosure and may not constitute prior art.

### SUMMARY

In one aspect of the disclosure, a battery pack includes a first housing arranged on the outmost side of the battery pack, a second housing arranged within the first housing, battery cells, which are at least partially contained in the second housing, and a filling body which is at least filled in a space between two adjacent battery cells. The filling body is arranged in the second housing. The filling body has a first specific heat capacity when a temperature of the filling body is below a first temperature and has a second specific heat capacity when the temperature of the filling body is above the first temperature.

Further areas of applicability will become apparent from the description provided herein. It should be understood that the description and specific examples are intended for purposes of illustration only and are not intended to limit the scope of the invention hereinafter claimed.

### BRIEF DESCRIPTION OF THE DRAWINGS

FIG. 1 is a schematic view showing a partial structure of an exemplary battery pack.

FIG. 2 is a schematic view showing an exemplary filling body and battery cells of the battery pack of FIG. 1.

FIG. 3 is a schematic view of the filling bodies in FIG. 2.

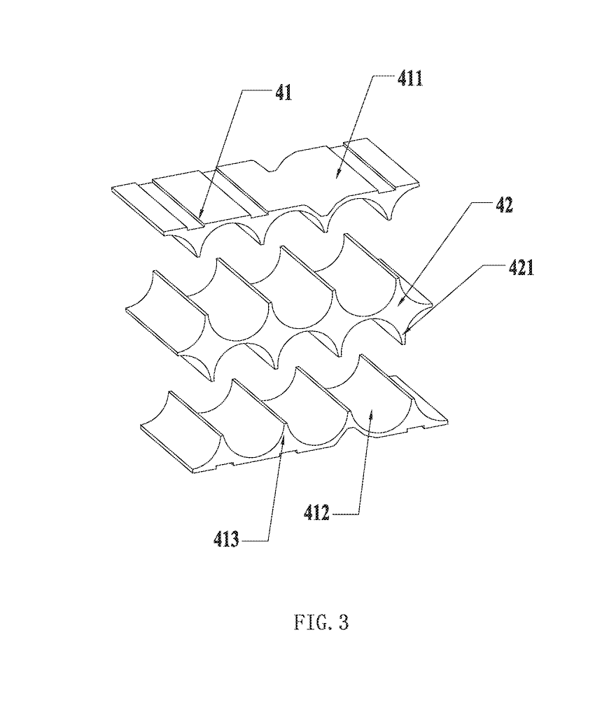

FIG. 4 is a schematic view showing another exemplary filling body and battery cells of a battery pack.

FIG. 5 is a schematic view of the filling body in FIG. 4.

The drawings described herein are for illustrative purposes only of selected embodiments and not all possible implementations, and are not intended to limit the scope of the invention hereinafter claimed. Corresponding reference numerals indicate corresponding parts throughout the several views of the drawings.

### DETAILED DESCRIPTION

The following description of the preferred embodiments is merely exemplary in nature and is in no way intended to limit the invention hereinafter claimed, its application, or uses.

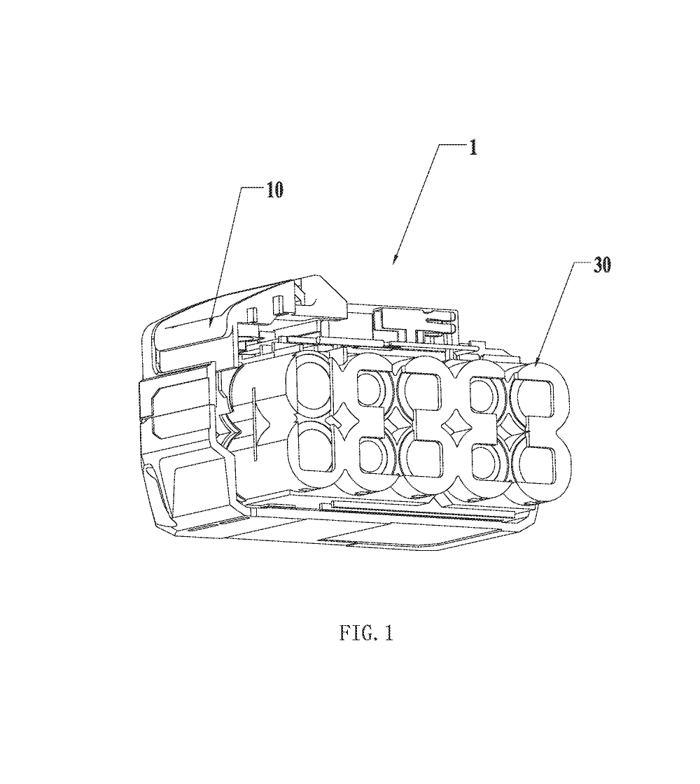

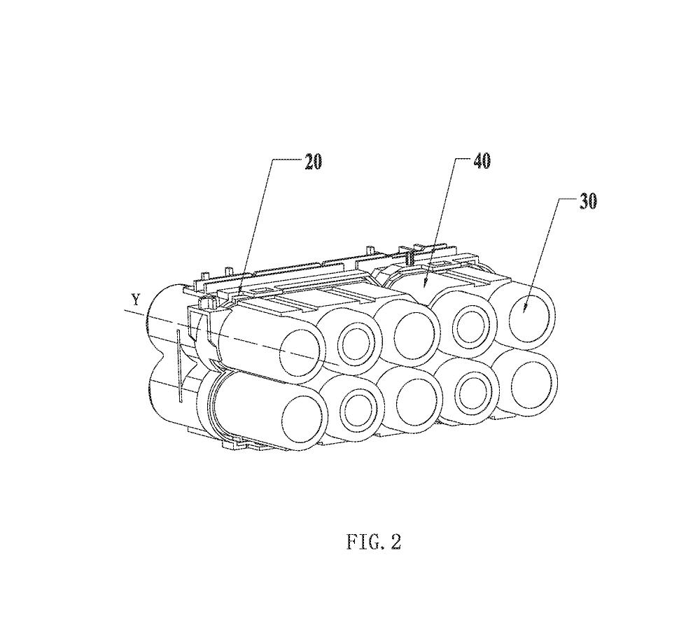

As shown in FIGS. 1-2, a battery pack 1 includes a first housing 10, a second housing 20, battery cells 30 and a filling body 40. The first housing 10 is arranged on the outmost side of the battery pack 1. The second housing 20 is arranged within the first housing 10. The battery cells 30 are at least partially contained in the second housing 20. The filling body 40 is at least filled in a space between adjacent battery cells 30. The filling body 40 is arranged in the second housing 20. The filling body 40 has a first specific heat capacity when a temperature of the filling body 40 is below a first temperature and has a second specific heat capacity when the temperature of the filling body 40 is above the first temperature.

The first housing 10 is used to assemble the battery pack 1 as a whole, which forms the outmost side of the battery pack 1. The first housing 10 can be made of plastic or rubber material. Preferably, the first housing 10 is made of two kinds of material. Specifically, the first housing 10 includes several basic bodies which are made of plastic material. The basic bodies are connected with each other through rubber material and/or the basic bodies are covered by rubber material. Thus, the battery pack 1 has high structural strength and a cushioning effect.

The second housing 20 is arranged within the first housing 10, which is used to fix battery cells 30 and the filling body 40. The second housing 20 is preferably made of plastic material. The second housing 20 is formed with a containing chamber for receiving the battery cells 30 and the filling body 40.

The battery pack 1 can include different numbers of battery cells 30, but at least two battery cells 30, according to its nominal voltage. The battery cells 30 are connected in series or in parallel. The battery cells 30 are partially contained in the second housing 20. Further, all the battery cells 30 are contained in the containing chamber of the second housing 20.

The filling body 40 is used to absorb the heat generated by the battery cells 30 during the charging and discharging process of the battery pack 1, thus slowing down the temperature rise of the battery cells 30 so the temperature of the battery pack 1 is inhibited from rising and can be cooled quickly.

The filling body 40 is arranged in the containing chamber of the second housing 20, which is filled in the space between adjacent battery cells 30. All the spaces between adjacent battery cells 30 are filled by the filling body 40. Thus, the quantity of the filling body 40 is increased and the effect of heat absorption is enhanced. The filling body 40 has the first specific heat capacity when the temperature of the filling body 40 is below the first temperature and has the second specific heat capacity when the temperature is above the first temperature. That is, the specific heat capacity of the filling body 40 varies with the temperature and the specific heat capacity of the filling body 40 varies with the charging time and discharging time so the effect of heat absorption of the filling body 40 varies with the temperature. Preferably, the second specific heat capacity is greater than the first specific heat capacity. Thus, the effect of heat absorption of the filling body 40 is better with the temperature rise of the battery pack 1. It is noted that the first and second specific heat capacity is applicable in the condition of phase change. The second specific heat capacity is very different from the first specific heat capacity and is applicable in the condition that the second specific heat capacity is slightly different from the first specific heat capacity when the temperature of the filling body 40 rises in the same condition.

As shown in FIG. 2, each battery cell 30 of the battery pack 1 has a central axis Y. The battery cells 30 are so arranged that the central axes Y of all the battery cells 30 are parallel to each other. The arranged battery cells 30 are configured as a battery cell group. The battery cell group may include edged cells that arranged at the edge thereof and middle cells that are surrounded by the edged cells. In the embodiment shown in FIG. 2, all the battery cells 30 of the battery cell group are edged cells. It is appreciated that the battery cell group can include middle cells when the number of the battery cells is increased.

The second housing 20 contains several filling bodies 40. According to the different positions and structure of the filling bodies, the several filling bodies 40 include a first filling body 41 and a second filling body 42. The first filling body 41 includes external surface 411 arranged at the edge of the battery cell group and internal surface 412 which is partially and directly contacted with the edged cells. The internal surface 412 is formed with first bulges 413 projecting toward the spaces inbetween adjacent battery cells 30. The first bulges 413 fill the partial spaces inbetween adjacent battery cells 30 so that the adjacent battery cells 30 are indirectly contacted with each other through the filling bodies 40. Thus, the adjacent battery cells 30 have the same cooling effect and the temperature equalization of the battery cell group is achieved and the individual battery cell 30 is avoided damage due to the over temperature rise.

The second filling body 42 is arranged within the battery cell group, which includes second bulges 421 projecting toward adjacent edged cells, adjacent middle cells, or adjacent edged cells and middle cells. That is, the second filling body 42 is at least partially surrounded by several edged cells or middle cells. So the adjacent middle cells and the adjacent middle cells and edge cells are indirectly contacted with each other through the filling bodies 40 and the temperature equalization of the battery cell group is well achieved. Further, the first bulges 413 of the first filling body 41 and the second bulges 421 of the second filling body 42 are contacted with each other so the first filling body 41 is engaged with the second filling body 42. The battery cells 30 in the second housing 20 are surrounded by more than two filling bodies 40 so that the surface of each battery cell 30 is fully contacted with the filling bodies 40.

The filling bodies 40 absorb heat when the temperature thereof rises to the first temperature and the temperature of the filling bodies 40 can rise to the first temperature during the discharging process of the battery cells 30. Preferably, the filling bodies 40 are made of phase change material and the first temperature is the phase transformation point of the phase change material. The phase transformation point of the phase change material is set between the highest temperature and the lowest temperature generated during the charging and discharging process of the battery pack 1. Thereby, during the charging and discharging process of the battery pack 1, the temperature of the filling bodies 40 can rise to the first temperature, and the phase change material can reach the phase transformation point and change phase so as to absorb lots of the heat.

The filling bodies 40 made of phase change material has a first specific heat capacity when the temperature thereof is below the first temperature and has a second specific heat capacity after changing phase, namely when the temperature thereof is above the first temperature. The second specific heat capacity is greater than the first specific heat capacity. As a result, the filling bodies 40 can absorb more heat after changing phase so as to inhabit the temperature of the battery cells 30 from rising. The phase change material, for example without limit, consists of 90%-99.9% of polyethylene glycol and 0.1%-10% of cellulose diacetate.

Preferably, the filling bodies 40 have a viscosity greater than 15 cP at the first temperature. When the phase change material changes phase, the viscosity after the phase change is less than that before the phase change. Here, the viscosity of the filling bodies 40 is defined greater than 15 cP after the phase change. Thus the phase change material cannot flow and shape of the phase change material cannot change to influence the cooling effect.

The second housing 20 of the battery pack 1 is used to not only mount the battery cells 30, but also fix the filling bodies 40. The second housing 20 is directly contacted with the filling bodies 40 and maintain the shape of the filling bodies 40.

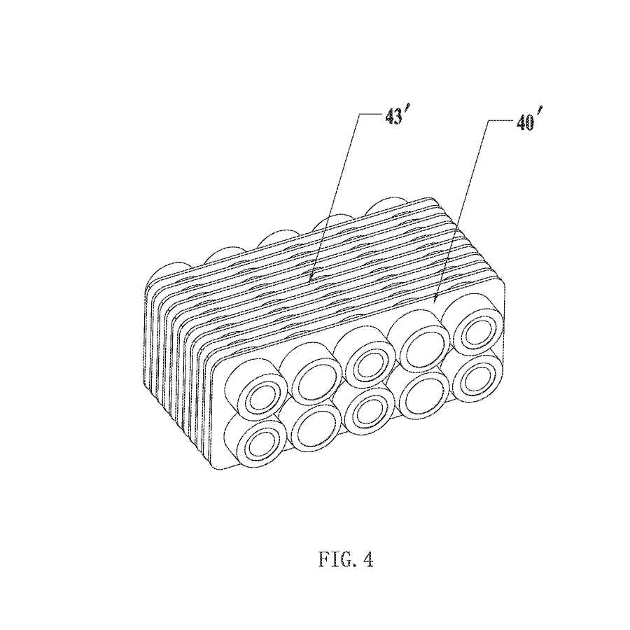

In order to enhance the cooling effect, the second housing 20 may be provided with an air flue as shown in FIG. 4. The air flue 43′ includes several recesses 431′ sunk from an outside surface of the second housing 20 departing from the battery cells toward the inside of the second housing 20. With the recesses 431′ on the outside surface of the second housing 20, the air flue 43′ is formed on the second housing 20. Thus, the air can flow within the battery pack 1 so as to enhance the cooling effect. Otherwise, the heat radiating area of the second housing 20 is increased due to the recesses 431′, and the cooling effect is further enhanced.

Preferably, in order to make the air flow from the inside to outside of the battery pack 1, the first housing 10 is provided with an air inlet and an air outlet so the air can cycle between the air inlet, the air flue and the air outlet. The temperature rise is slowed down during the charging and discharging process of the batter pack 1.

Preferably, the filling bodies 40 further include basic material which is used to support the phase change material. The basic material has a porous structure. The phase change material is filled in the porous structure. A part of the battery cells 30 that is contained in the second housing 20 is surrounded by the filling bodies 40. The basic material is elastic material.

Preferably, the first temperature is between 50-60 degrees C. Namely, the phase transformation point of the phase change material is between 50-60 degrees C. With the filling bodies 40 being filled between the battery cells 30, the temperature of the battery cells 30 can at least drop about 15 degrees C. in a condition that the battery pack 1 is discharged with the discharging current of 40A and ended the discharging process in 330 seconds. Thus, the cooling effect is enhanced greatly due to the filling bodies 40 between the battery cells 30.

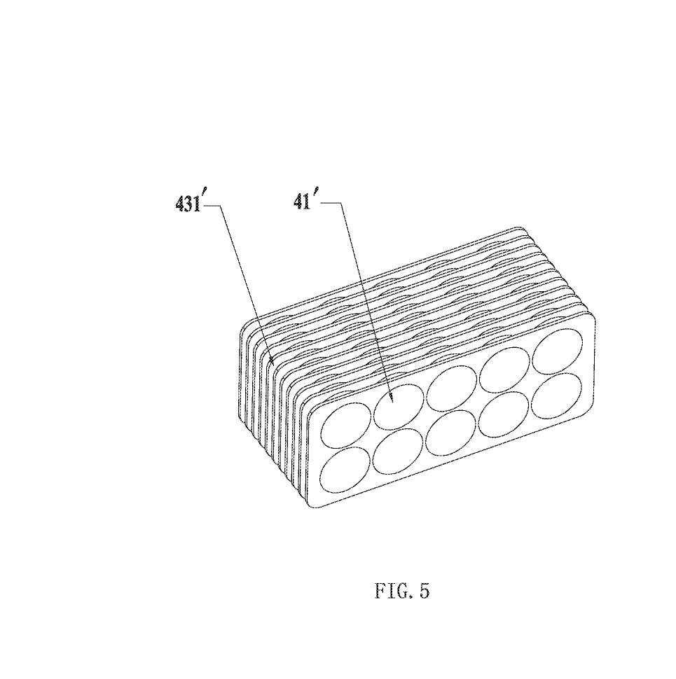

Referring to FIGS. 4-5, illustrated is a battery pack 1 having the same first housing 10, the second housing, and the battery cells 30 as described above. The difference between this illustrated battery pack and the previously described battery pack is that a filling body 40′is integrally formed. Specifically, the filling body 40′is made of high polymer material. The high polymer material has a first specific heat capacity which is greater than 1.5 J/g. degrees C. Thus, even the high polymer material does not change phase, it can provide good cooling effect. The high polymer material may be polypropylene or silicone rubber material. The filling body 40′ is formed with several chambers 41′ extending along the central axis Y. The battery cells 30 are arranged in the chambers 41′ respectively. The chambers 41′ have inside surfaces which are directly contacted with the battery cells 30. In other embodiments, the battery pack 1 may not include the second housing 20. The air flue can be formed on the outside surface of the filling body 40.

The above illustrates and describes basic principles, main features and advantages of the present invention. Those skilled in the art should appreciate that the above embodiments do not limit the present invention in any form. Technical solutions obtained by equivalent substitution or equivalent variations all fall within the scope of the invention hereinafter claimed.

What is claimed is:

1. A battery pack, comprising:
a first housing arranged on the outmost side of the battery pack;
a second housing arranged within the first housing;
a plurality of battery cells, which are at least partially contained in the second housing; and
a filling body which is at least filled in a space between two adjacent one of the plurality of battery cells;
wherein the filling body is arranged in the second housing, and wherein the filling body has a first specific heat capacity when a temperature of the filling body is below a first temperature and has a second specific heat capacity when the temperature of the filling body is above the first temperature.

2. The battery pack of claim 1, wherein the filling body absorbs heat when the temperature thereof rises to the first temperature and the temperature of the filling body is caused to rise to the first temperature when the battery cells are discharged.

3. The battery pack of claim 2, wherein the filling body consists of a phase change material alone and the phase change material has a phase transformation point which is equal to the first temperature.

4. The battery pack of claim 1, wherein the second housing contains more than two filling bodies and at least a part of the plurality of battery cells that is contained in the second housing is surrounded by the more than two filling bodies.

5. The battery pack of claim 4, wherein each filling body is formed with a bulge projecting toward the space between two adjacent ones of the plurality of battery cells.

6. The battery pack of claim 1, wherein the filling body has a viscosity which is greater than 15cP at the first temperature.

7. The battery pack of claim 1, wherein the second housing is provided with an air flue and the air flue comprises at least a recess sunk from an outside surface of the second housing departing from the plurality of battery cells towards an inside of the second housing.

8. The battery pack of claim 1, wherein the filling body comprises a material with a porous structure and phase change material which is filled in the porous structure.

9. The battery pack of claim 8, wherein at least a part of the plurality of battery cells that is contained in the second housing is surrounded by the filling body and the basic material is elastic material.

10. The battery pack of claim 1, wherein the filling body is made from high polymer material, the high polymer material has the first specific heat capacity which is greater than 1.5 J/g. degrees C., and the filling body is provided with several chambers for containing the battery cells.
